(19) United States
(12) Patent Application Publication
(10) Pub. No.: US 2010/0140053 A1
(43) Pub. Date: Jun. 10, 2010

(54) SPACE-SAVING SORTING PLANT AND METHOD FOR SORTING ARTICLES

(75) Inventors: Peter Berdelle-Hilge, Konstanz (DE); Ottmar Kechel, Stockach (DE); Walter Rosenbaum, Paris (FR); Torsten Tanz, Hilzingen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/634,196

(22) Filed: Dec. 9, 2009

Related U.S. Application Data
(60) Provisional application No. 61/120,952, filed on Dec. 9, 2008.

(30) Foreign Application Priority Data
Jan. 19, 2009 (DE) 10 2009 005 091.4

(51) Int. Cl. B65G 47/30

(52) U.S. Cl. 198/426

(57) ABSTRACT

A sorting plant and method for sorting articles, especially flat mail consignments, include a conveying device, a transfer mechanism and at least one reception device. A conveying transport mechanism of the conveying device transports an article along a conveyor track. The reception device has a plurality of reception components for at least one respective article and a reception transport mechanism. The reception transport mechanism moves the reception components along a reception component track and simultaneously brings one respective reception component of the reception device into a transfer position. The reception component track has a reception segment proceeding vertically or obliquely from the top downward. The transfer mechanism brings an article from the conveying device into one of the reception devices when the article is located at a transfer point on the conveyor track and when this reception component is located in a transfer position with respect to the transfer point.

### CROSS-REFERENCE TO RELATED APPLICATION

This is a Non-Provisional of U.S. Application No. 61/120,952, filed Dec. 9, 2008; this application also claims the priority, under 35 U.S.C. §119, of German Patent Application DE 10 2009 005 091.4, filed Jan. 19, 2009; the prior applications are herewith incorporated by reference in their entirety.

### BACKGROUND OF THE INVENTION

### Field of the Invention

The invention relates to a sorting plant and to a method for the sorting of articles, in particular of flat mail consignments.

Two sorting plants for flat mail consignments are described in U.S. Pat. No. 6,644,461 B1 and U.S. Pat. No. 7,199,323 B2. The sorting plants described therein have a reception device with a plurality of reception compartments. The reception device has a reception transport mechanism which is configured for transporting the reception compartments along a conveyor track which extends in a horizontal plane. In each case a mail consignment is transported upright in one of the reception compartments. For that purpose, the reception transport mechanism moves the reception device in such a way that the reception compartment is located at the end of a feed device. The feed device has a plurality of rollers which rotate in each case about a vertical axis of rotation and thereby move the mail consignment toward the reception compartment.

U.S. Pat. No. 6,953,906 B2 describes a sorting plant for mail consignments, which includes feed devices (“inducts”), sorting devices (“sorting assemblies”) and a plurality of output devices. Each output device has a chute through the use of which mail consignments slide into a container. That container rests on a conveyor belt which transports filled containers away and which feeds empty containers. In one embodiment, the chutes are disposed in a plurality of rows lying one above the other, and two conveyor belts lying one above the other lead through under the chutes. A kind of elevator can feed containers to the conveyor belts.

International Publication No. WO 2006/100599 A1, corresponding to U.S. Patent Application Publication Nos. US 2009/0060698 and US 2009/0050541, describes a sorting plant including a conveyor belt which is subdivided into sections as well as a transport device with pockets or other containers for mail consignments. The transport device transports the pockets along a closed conveyor track. Mail consignments are introduced into the pockets. Those mail consignments subsequently fall down onto each section, in that in each case a pocket is positioned above a specific section and the pocket is opened downward.

A sorting plant and a sorting method are known from U.S. Pat. No. 6,555,776 B2. U.S. Pat. No. 6,555,776 B2 describes a sorting plant for mail consignments which sorts mail consignments accurately according to a round sequence (“delivery sequence sorting”). That sorting plant includes an address reader, which reads the address or sorting information on a mail consignment as well as a horizontal feed conveyor section (“transport/sorter conveyor 20”). The horizontal feed conveyor section 20 leads over and beyond a series of “sequencing modules 22”. Each of those modules 22 has two vertical portions and a multiplicity of reception devices (“loading trace 78”). Below that series of reception modules 22 is located a horizontal leading-away conveyor section 90 on which still open containers 88 stand. A mail consignment is transported by the feed conveyor section 20 as far as a reception module 22 and passes from there into a reception device 78. In that reception device 78, the mail consignment is transported downward and slides from there into a container 88 on the leading-away conveyor section 90. Thus, in each container 88, a specific sequence can be established among the mail consignments in that container.

European Patent Application EP 1 872 871 A1 describes a sorting plant for mail consignments with a “routing area RA” and with a “casing area CA”. The “routing area RA” has a transport mechanism. The “casing area CA” has a plurality of “casing towers 1”, and each “casing tower 1” has a plurality of reception devices (“slots”) in each case for mail consignments.

A mail consignment passes through the “routing area RA” into a “casing tower 1” and from there into an “extraction area EA” where mail consignments are sorted according to round sequence. A “casing tower 1” can transport mail consignments from an upper level 12a to a lower level 12b downward or, conversely, from the bottom upward and, for that purpose, has a vertically operating “two-level conveyor system 12”.

German Published, Non-Prosecuted Patent Application DE 35 30 624 A1 describes a sorting station with a conveying device, a reception device and a transfer mechanism. A multiplicity of article repositories 32, 32′ function as a reception device and are taken along through the use of conveyor sections 17, 17′ of a take-along and transport member 16.

The two conveyor section chains 17, 17′ are led around four deflecting rollers 12, 13, 14, 15 and run in each case in a vertical plane. In one embodiment, the article repositories 32, 32′ are disposed symmetrically with respect to a vertical longitudinal mid-plane 33. A loading station 7 can fill those article repositories 32, 32′. In that case, at least one article slides out of the loading station into an article repository 32. The article repository 32 can be tilted, so that an article can slide out of the article repository 32 into the container 72.

German Published, Non-Prosecuted Patent Application DE 43 00 758 A1 describes a sorting plant with a multiplicity of reception devices, for example compartments for flat articles. The reception devices are, for example, disposed in the manner of two parallel bookshelf walls. A horizontal conveying device 13 has two horizontal conveyor sections for the transportation of flat articles standing upright. Below the horizontal conveying device 13 is located a vertical conveying device 18 with two vertical endless conveyor belts. Each vertical endless conveyor belt has two vertical portions in each case and is led around two horizontal axes. A plurality of pockets 17 are disposed in each case on each vertical endless conveyor belt.

An article is transported by the horizontal conveying device 13 into a transfer position above the vertical conveying device 18 and slides into a pocket 17. The vertical conveying device 18 transports the article in the pocket 17 to a reception device.

### SUMMARY OF THE INVENTION

It is accordingly an object of the invention to provide a space-saving sorting plant and a method for sorting articles, which overcome the hereinafore-mentioned disadvantages of the heretofore-known plants and methods of this general type and in which the reception device requires less floor area (“footprint”) than in the sorting plants and sorting methods known from the prior art.

With the foregoing and other objects in view there is provided, in accordance with the invention, a sorting plant and a sorting method, comprising:

a conveying device,

a transfer mechanism, and

at least one reception device.

The conveying device has a conveying transport mechanism. The conveying transport mechanism is configured for transporting an article along a conveyor track.

At least one transfer point is located on the conveyor track.

The at least one reception device has:

a plurality of reception components in each case for at least one article and

a reception transport mechanism.

The reception transport mechanism of this at least one reception device is configured for moving the reception components along a reception component track and at the same time for bringing in each case one reception component of the reception device into a transfer position.

The at least one reception device is configured in such a way that the reception component track has a reception segment proceeding vertically or obliquely from the top downward or conversely from the bottom upward.

The transfer mechanism is configured for bringing an article from the conveying device into one of the reception devices when the article is located at one of the transfer points on the conveyor track.

The transfer mechanism can bring an article located at a transfer point into a reception component of a reception device when this reception component is located in a transfer position with respect to the transfer point.

This sorting plant requires less floor area, particularly because the reception component track has a reception segment proceeding vertically or obliquely from the top downward. Since the at least one reception device has a plurality of reception components, the sorting plant can distribute articles to more different reception components in one sorting run than known sorting plants can do.

According to the invention, the conveyor track has two conveying segments which lie vertically or obliquely one above the other.

The lower conveying segment includes a lower transfer point. The upper conveying segment includes an upper transfer point. The vertical or oblique reception segment is disposed in such a way that the reception transport mechanism can move each reception component of the reception device both into a transfer position with respect to the lower transfer point and into a transfer position with respect to the upper transfer point.

This refinement saves time for sorting the articles. If it is not possible to bring an article at one transfer point from the conveyor track into this reception device, it is sufficient to transport the article through the conveyor track to the other transfer point where the article can then be brought into this reception device. It is not necessary to transport the article to the same transfer point again over the entire conveyor track, which would take up considerably more time.

In accordance with a concomitant feature of the invention, an especially large amount of floor area is saved if the at least one reception device is configured as a paternoster having a closed reception component track. The reception component track has two vertical reception segments.

Other features which are considered as characteristic for the invention are set forth in the appended claims.

Although the invention is illustrated and described herein as embodied in a space-saving sorting plant and a method for sorting articles, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, top-plan view of a sorting plant of an exemplary embodiment of the invention;

FIG. 2 is a side-elevational view of the sorting plant, which is taken along a line II-II of FIG. 1, in the direction of the arrows; and

FIG. 3 is a front-elevational view of the sorting plant, which is taken along a line III-III of FIG. 1, in the direction of the arrows.

### DETAILED DESCRIPTION OF THE INVENTION

In the exemplary embodiment, the sorting plant is used for sorting flat mail consignments (standard letters, large letters, postcards, newspapers, catalogs and the like). Each mail consignment is given indications as to the respective destination address to which the mail consignment is to be transported.

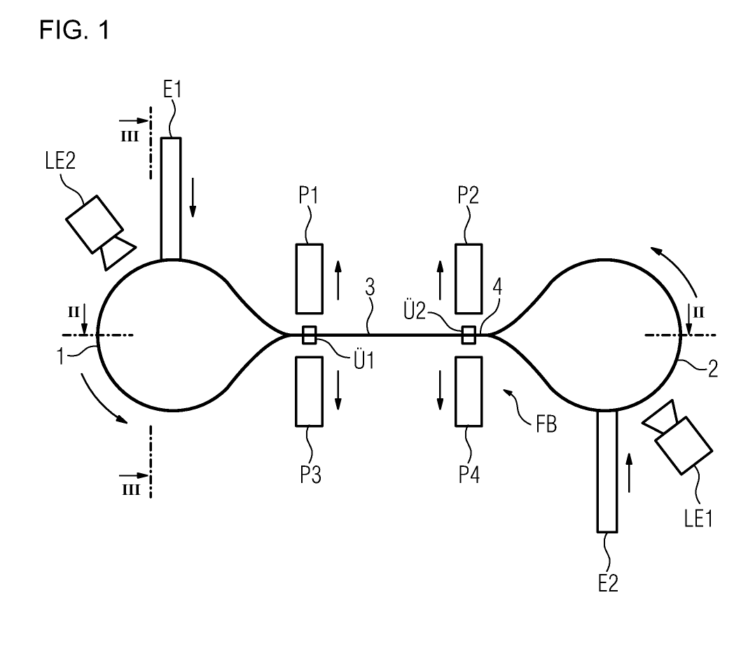

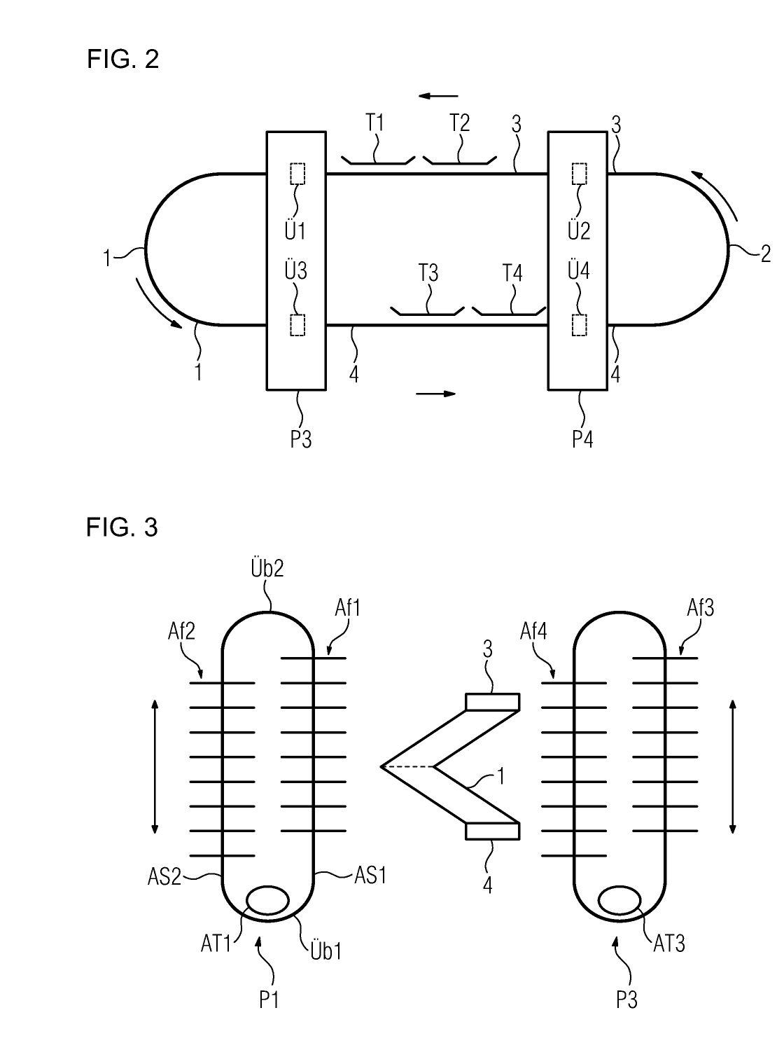

Referring now to the figures of the drawings in detail and first, particularly, to FIG. 1 thereof, there is seen a sorting plant of the exemplary embodiment in a top view. FIG. 2 shows the sorting plant in a side view in the plane II-II of FIG. 1. FIG. 3 shows the sorting plant in a front view in the plane III-III of FIG. 1.

This sorting plant includes:

two feed devices E1, E2,

two reading devices LE1, LE2,

a conveying device,

a reception component determination device,

a synchronizing mechanism, and

a plurality of reception devices, of which four reception devices P1, P2, P3, P4 are shown.

The conveying device transports mail consignments in a conveying direction which is indicated by arrows in FIG. 1 and FIG. 2.

The conveying device has:

a sequence of conveyor belts and

a conveying transport mechanism.

The sequence of conveyor belts describes a conveyor track FB. In the exemplary embodiment, this conveyor track FB is a closed curve in space and includes:

an upper straight and horizontally proceeding section 3 of the conveyor track FB,

a lower straight and horizontally proceeding section 4 of the conveyor track FB,

a transition 1 from the upper segment 3 to the lower segment 4, and

a transition 2 from the lower segment 4 to the upper segment 3.

The two feed devices E1, E2 and the two reading devices LE1, LE2 are disposed in such a way that:

the reading device LE1, as seen in the conveying direction, is disposed downstream of the feed device E1,

as long a transport path as possible lies between the reading device LE1 and the reception device lying nearest to LE1, as seen in the conveying direction, and

as long a transport path as possible lies between the reading device LE2 and the reception device lying nearest to LE2.

The upper section 3 is located vertically above the lower section 4. This configuration avoids the disadvantage of a closed conveyor track which extends in one plane, to be precise a space which is enclosed by a conveyor track and where access is difficult.

In one refinement, the conveyor belts are configured in such a way that the mail consignments are transported upright. For example, the conveyor belts form a U-shaped transport channel, and each mail consignment leans against a side wall. In another refinement, the mail consignments lie horizontally on the conveyor belts. In both refinements, the conveying device can transport mail consignments of different dimensions along the conveyor track FB.

A plurality of transfer points are located along the conveyor track FB. Two transfer points Ü1 and Ü2 thereof on the upper conveying segment 3 and two transfer points Ü3 and Ü4 thereof on the lower conveying segment 4 are shown.

In the exemplary embodiment, the conveyor track FB, the transfer points Ü1 to Ü4 and the reception devices P1 to P4 in the form of paternosters, are disposed in such a way that a mail consignment, when it runs once through the entire conveyor track FB, passes the same paternoster twice, to be precise it passes at two different transfer points to the same paternoster at two different time points. As a result, a mail consignment which could not be brought into the correct paternoster at the first time point can be transferred into this paternoster at the second time point, without the mail consignment having to run through the entire conveyor track FB.

In the exemplary embodiment, a mail consignment can be brought from the conveying device into a reception component when:

the mail consignment has been transported to the transfer point Ü1 and the reception component belongs to the reception device P1 or to the reception device P3 and is located in a transfer position with respect to the transfer point Ü1, or

the mail consignment has been transported to the transfer point Ü3 and the reception component belongs to the reception device P1 or to the reception device P3 and is located in a transfer position with respect to the transfer point Ü3, or

the mail consignment has been transported to the transfer point Ü2 and the reception component belongs to the reception device P2 or to the reception device P4 and is located in a transfer position with respect to the transfer point Ü2, or

the mail consignment has been transported to the transfer point Ü4 and the reception component belongs to the reception device P2 or to the reception device P4 and is located in a transfer position with respect to the transfer point Ü4.

In the exemplary embodiment, the conveyor belts are constantly moved in the same direction in continuous operation. This direction is indicated in the figures by arrows. A mail consignment which is introduced by the feed device E1 onto the conveyor track runs first through the transition 1, subsequently through the lower conveying segment 4, then through the transition 2, subsequently through the upper conveying segment 3 and then through the transition 1 again, if it has not previously been discharged.

Each transfer point is assigned at least one reception device. Conversely, each reception device is assigned to at least one transfer point. A transfer point may be assigned a plurality of reception devices. Conversely, a reception device may be assigned a plurality of transfer points. In the examples shown in the figures, the transfer point Ü1 is assigned the two reception devices P1 and P3, the transfer point Ü3 is likewise assigned the two reception devices P1 and P3, the transfer point Ü2 is assigned the two reception devices P2 and P4 and the transfer point Ü4 is likewise assigned the two reception devices P2 and P4. Conversely, the reception device P1 is assigned the two transfer points Ü1 and Ü3, and so on and so forth.

A mail consignment can be brought from the conveying device into a reception component of a reception device when:

the mail consignment is located at a transfer point which is assigned to the reception device and, at the same time,

the reception component is positioned in a transfer position with respect to this transfer point.

The exemplary embodiment saves an especially large amount of floor area. This is achieved particularly in that the two conveying segments 3 and 4 are disposed one above the other and the reception devices P1, P2, etc. are disposed in two rows on both sides of the two conveying segments 3 and 4. The conveyor track is therefore led through between the two rows of reception devices. As a result, each reception device can receive mail consignments from both conveying segments 3 and 4. Each reception device is assigned in each case to a transfer point of the upper conveying segment 3 and of the lower conveying segment 4.

In the exemplary embodiment, each reception device P1, P2, etc. has in each case:

a plurality of reception components and

a reception transport mechanism.

A plurality of reception components Af1, Af2, etc. are shown by way of example in FIG. 3. Each reception component is configured for receiving at least one horizontally lying mail consignment. In a refinement, each reception component is configured as a reception compartment which is between 4 cm and 10 cm high and which has a horizontal reception area that is larger than each sorted mail consignment.

Furthermore, FIG. 3 shows a reception transport mechanism AT1 of the reception device P1 and a reception transport mechanism AT3 of the reception device P3.

In the exemplary embodiment, the four reception devices P1, P2, P3 and P4 as well as further non-illustrated reception devices, are configured as paternosters. The reception transport mechanism of a reception device can move the reception components of this reception device along a closed reception component track, specifically in both directions. This is indicated in FIG. 3 by double arrows. This reception component track has:

two vertical reception segments and

two semicircular transition segments between these reception segments.

The reception component track lies in a vertical plane. This vertical plane is perpendicular to the two straight conveying segments 3 and 4 of the conveyor track FB. FIG. 3 shows two vertical reception segments AS1 and AS2 as well as two transition segments Üb1 and Üb2 of the paternoster P1.

Each reception component is disposed in such a way that the base area remains horizontal during a movement of the reception components along the reception component track. As a result, a mail consignment which is located in the reception component remains in this reception component and does not fall out.

In an alternative refinement, each reception component includes a reception pocket. A mail consignment can be displaced into this reception pocket and lies obliquely or vertically in this reception pocket.

A reception component determination device includes:

the two reading devices LE1, LE2 and

a computer-available sorting plan.

Each reading device LE1, LE2 can determine the respective destination address with which a mail consignment is provided. The sorting plan in each case assigns a specific reception component of a reception device to each possible destination address.

The transfer mechanism is configured for bringing a mail consignment from the conveying device into a reception device when the mail consignment is located at a transfer point.

The mail consignments are delivered in stacked form. Each feed device E1, E2 is configured for separating the mail consignments and for feeding the separated mail consignments to the conveying device. In the exemplary embodiment, the mail consignments are fed in such a way that each mail consignment fed lies flat on a conveyor belt of the conveying device. Preferably, the mail consignments lie one behind the other on the conveyor belt, so that a plurality of mail consignments do not lie one above the other. It is thereby possible to bring a mail consignment into a reception component, without another mail consignment being pushed by the conveyor belt.

The conveying transport mechanism moves these conveyor belts. As a result, the conveying transport mechanism has the effect that each mail consignment lying on a conveyor belt is transported along a section of the conveyor track FB in a conveying direction. This section starts in one of the two feed devices E1, E2 and ends at a transfer point. The speed at which these conveyor belts move is measured and is therefore known.

Each mail consignment passes one of the two reading devices LE1, LE2. This reading device LE1 or LE2 determines the destination address of the mail consignment. In one embodiment, for this purpose, the reading device evaluates the indications as to the destination address on the mail consignment. Initially, the reading device attempts to decipher the destination address automatically by “optical character recognition” (OCR). If this is not possible, an image of the mail consignment is displayed on a visual display unit of a video coding station. A worker reads the destination address and at least partially inputs the destination address.

In another embodiment, this destination address has already been read, and a machine-readable coding of this destination address is printed onto the mail consignment, for example in the form of a bar pattern (“bar code”). The reading device scans this coding and decodes it in order to determine the destination address.

The reception component determination device determines that reception device and that reception component of this reception device into which the mail consignment is to be transported. One of the two reading devices LE1, LE2 has determined the destination address. The sorting plan stipulates the reception component.

The synchronizing mechanism is connected both to the conveying transport mechanism and to the respective conveying transport mechanism of each reception device and, moreover, to each reading device LE1, LE2. As soon as a mail consignment has passed a reading device LE1, LE2, it is clear to which reception device this mail consignment is to be transported. The synchronizing mechanism determines a transfer point which is assigned to this reception device.

For example, a mail consignment is introduced by the feed device E2 onto the conveyor track FB, and the reading device LE2 reads the destination address of a mail consignment. The reception component determination device determines that this mail consignment is to be transported into the reception component Af3 of the reception device P3. This mail consignment is first transported through the transition 2, subsequently through the upper conveying segment 3, the transition 1, the lower conveying segment 4 and then again through the transition 2, if it has not been discharged previously. The reception device P3 is assigned the two transfer points Ü1 on the upper conveying segment 3 and Ü3 on the lower conveying segment 4. The mail consignment will first pass the transfer point Ü1 and thereafter the transfer point Ü2. The reception component determination device therefore decides that the mail consignment is discharged into the reception component Af3 at the transfer point Ü1.

The synchronizing mechanism activates the reception transport mechanism of the reception device P3. Thereupon, the reception transport mechanism moves the reception components of the reception device P3 along the reception component track in such a way that the reception component Af3 is brought into a transfer position with respect to the transfer point Ü1 previously determined.

The configuration of the conveyor tracks meanwhile moves at a constant speed and transports the mail consignment from the reading device LE2 to the transfer point Ü1.

In the exemplary embodiment, each reception device (paternosters P1 to P4) can be reached at two transfer positions from the conveyor belt FB. If the mail consignment reaches the transfer point Ü1 before the reception transport mechanism has brought the reception component Af3 into the transfer position with respect to the transfer point Ü1, the conveyor belt FB preferably transports the mail consignment further on to the transfer point Ü3. The reception transport mechanism moves the reception component Af3 in the meantime into the transfer position with respect to the transfer point Ü3. It is not necessary to transport the mail consignment over the entire conveyor track FB until it reaches the transfer point Ü1 again. Furthermore, there is no need to slow a conveyor belt.

In an alternative refinement, the synchronizing mechanism stops the conveying device temporarily or even halts it. In the additional time span thereby gained, the reception transport mechanism moves the reception component into the transfer position with respect to the transfer point Ü1.

In a third refinement, the mail consignment is discharged into an overflow compartment and is later fed to the sorting plant again through one of the two feed devices E1, E2.

As a rule, however, the reception component Af3 reaches the transfer position earlier than the mail consignment reaches the transfer point Ü1 because the mail consignment has a longer distance to cover.

As soon as the reception component Af3 is located in the transfer position with respect to the transfer point Ü1 and the mail consignment has reached the transfer point Ü1, the transfer mechanism brings the mail consignment into the reception component Af3. If required, the conveying device is briefly stopped, although this is not usually necessary. As soon as the mail consignment has been removed from the conveyor belt, the conveying device is set in movement again.

In a first refinement, the transfer mechanism includes in each case one horizontally operating slide per transfer point. This slide exerts upon the mail consignment an impulse which is perpendicular to the direction in which the mail consignment is transported. As a result, the slide displaces a mail consignment horizontally from the conveyor belt into the reception component. The slide includes, for example, a metal sheet which is pulled together and thereby displaces the mail consignment laterally.

In a second refinement, the conveying device includes a multiplicity of transport trays which are constructed as tilting trays. A plurality of transport trays T1, T2, etc. are indicated in FIG. 2. Each reception component includes a reception pocket. Each mail consignment is brought horizontally onto one of these tilting trays by a feed device E1, E2. As soon as a mail consignment is located at the respective transfer point and the reception component determined is in the transfer position, the transfer mechanism tilts the tilting tray on which the mail consignment lies. The mail consignment thereby slips from the tilting tray obliquely into the reception pocket.

In a third refinement, the conveying device includes a multiplicity of cross belts. Each mail consignment is laid onto a cross belt. As soon as a mail consignment is located at the respective transfer point and the reception component determined is in the transfer position, the transfer mechanism moves the cross belt having the mail consignment. The mail consignment is thereby moved transversely with respect to the conveyor track and passes into the reception component. This third refinement can be implemented both together with reception pockets and together with horizontal reception areas.

The sorting plant distributes to the reception components all those mail consignments which reach the sorting plant within a specific period of time. When all of these mail consignments are distributed, the distributed mail consignments have to be transported away.

In one refinement, in each case N reception components of a reception device are connected firmly to form a block. When all of the mail consignments are distributed, each block, together with the mail consignments in the N reception components of the block, is extracted from the reception device and transported away. This refinement avoids the need for a reprocessing of the distributed mail consignments.

In an alternative refinement, the distributed mail consignments are extracted from the reception components and brought into containers. In order to ensure that distribution is not destroyed again, in each case a separating element (“separator”) is inserted between the mail consignments from two different reception components. This separating element differs visually from the mail consignments and is, for example, a separating card which is larger than the largest sorted mail consignment. This refinement saves space, as compared with the first refinement.

The sorting plant according to the invention makes it possible, in a single sorting run, to distribute mail consignments to more reception compartments than known sorting plants, without the area requirement being increased. If the sorting plant includes n reception devices and each of these reception devices has in each case m reception components, the sorting plant can distribute mail consignments to m*n reception components in one sorting run. In an exemplary embodiment, the two horizontal conveying segments 3 and 4 are, for example, in each case approximately 30 m long. The two transitions 1 and 2 occupy in each case a square floor area with a side length of about 5 m. On this area, n=100 reception devices, each with m=100 reception components, can be mounted along the two conveying segments 3 and 4, to be precise 50 on each side, so that, in a single sorting run, the sorting plant can sort to m*n=10,000 reception components.

Preferably, the sorting plant includes at least two further reception devices including a single reception container and no transport mechanism. One further reception device receives mail consignments to a major recipient to which a large number of mail consignments are addressed. The other further reception device functions as an overflow compartment for mail consignments, the destination address of which cannot be recognized or which are not machine-capable.

1. A sorting plant, comprising:
a conveyor track having two conveying segments lying vertically or obliquely one above the other defining a lower conveying segment including at least one lower transfer point and an upper conveying segment including at least one upper transfer point;
a conveying device having a conveying transport mechanism configured for transporting an article along said conveyor track;
at least one reception device having a plurality of reception components each for receiving at least one respective article and having a reception transport mechanism;
a transfer mechanism configured for bringing an article from said conveying device into a reception device upon the article being located at a transfer point;
said reception transport mechanism being configured for moving said reception components along a reception component track and for simultaneously bringing each respective reception component of said reception device into a transfer position;
said transfer mechanism being configured for bringing an article located at a transfer point into a reception component of a reception device upon said reception component being located in a transfer position with respect to said transfer point;
said at least one reception device being configured with said reception component track having at least one reception segment proceeding vertically or obliquely from a top downward; and
said vertical or oblique reception segment permitting said reception transport mechanism to move each reception component of said reception device both into a transfer position with respect to said lower transfer point and into a transfer position with respect to said upper transfer point.

2. The sorting plant according to claim 1, wherein said at least one reception device is a paternoster with a closed reception component track, and said reception component track has two vertical reception segments.

3. The sorting plant according to claim 2, wherein said reception device is configured with each reception component located in a transfer position when said reception component is moved in one of said two vertical reception segments.

4. The sorting plant according to claim 1, wherein said reception transport mechanism is configured to selectively move said reception components along said reception component track in one direction or another direction.

5. The sorting plant according to claim 1, wherein said upper transfer point is located vertically or obliquely above said lower transfer point.

6. The sorting plant according to claim 1, wherein said conveying track, along which said conveying device moves, is a closed curve.

7. The sorting plant according to claim 1, which further comprises:
a reception component determination device configured for determining a reception device and a reception component of said reception device in which the article is transported, as a destination for an article transported by said conveying device; and
a synchronizing mechanism configured for synchronizing said conveying transport mechanism and said reception transport mechanism to cause said conveying transport mechanism to begin to bring a reception component into said transfer position after said reception component determination device has determined said reception component as a destination for a transported article and while said conveying device is still transporting the article.

8. The sorting plant according to claim 1, wherein:
said at least one reception device includes a first reception device and a second reception device;
said transfer points include a first transfer point and a second transfer point lying on said conveyor track;
said transfer mechanism is configured to bring an article located at said first transfer point into a reception component of said first reception device when said reception component is located in a transfer position with respect to said first transfer point; and
said transfer mechanism is configured to bring an article located at said second transfer point into a reception component of said second reception device when said reception component is located in a transfer position with respect to said second transfer point.

9. The sorting plant according to claim 8, wherein said first transfer point coincides with said second transfer point, and said first reception device and said second reception device define a clearance therebetween.

10. The sorting plant according to claim 8, wherein said conveyor track is led through between said first reception device and said second reception device.

11. The sorting plant according to claim 8, which further comprises:
a first feed device and a second feed device each configured for feeding an article to said conveying device;
said conveyor track being a closed curve along which said conveying device can transport an article; and
said closed conveyor track first leading past said first feed device, then reaching said first transfer point, then leading past said second feed device and then reaching said second transfer point.

12. A method for sorting articles, the method comprising the following steps:
transporting the articles with a conveying device along a conveyor track having two conveying segments lying vertically or obliquely one above the other and defining a lower conveying segment including at least one lower transfer point and an upper conveying segment including at least one upper transfer point;
bringing each respective article from the conveying device into at least one reception device with a transfer mechanism when the article is located at a transfer point of the conveyor track;
bringing an article located at a transfer point into a reception component of the at least one reception device with the transfer mechanism upon the reception component being located in a transfer position with respect to the transfer point;
moving the reception components of the at least one reception device along a reception component track having a section proceeding vertically or obliquely from a top downward, with a reception transport mechanism of the at least one reception device and simultaneously bringing each respective reception component into a transfer position, with the reception transport mechanism; and
moving each reception component of the at least one reception device through the vertical or oblique reception segment with the reception transport mechanism, both into a transfer position with respect to the lower transfer point and into a transfer position with respect to the upper transfer point.
